(19) United States
(12) Patent Application Publication
(10) Pub. No.: US 2010/0219586 A1
(43) Pub. Date: Sep. 2, 2010

(54) QUICK RELEASE BELLOW SEAL GUARD

(75) Inventors: MATTHEW A. McGINNITY, Timonium, MD (US); WARREN N. KOUNS, Baltimore, MD (US)

Correspondence Address: HARNESS, DICKEY & PIERCE, P.L.C., P.O. BOX 828, BLOOMFIELD HILLS, MI, 48303, US

(73) Assignee: EMERSON POWER TRANSMISSION MANUFACTURING, Maysville, KY (US)

(21) Appl. No.: 12/394,418

(22) Filed: Feb. 27, 2009

(51) Int. Cl. F16J 15/44

(52) U.S. Cl. 277/411

(57) ABSTRACT

A quick release bellow seal guard for use with a shaft assembly having a first guard member having an open central region and a second guard member releasably coupled to the first guard member also having an open central region. The first guard member further includes a wall extending from a base portion to a distal end. The second guard member further includes a proximal end releasably coupled to the distal end of the first guard member to collectively define an interior guard volume. The quick release bellow seal guard further includes a seal member sealingly engaging at least one of the first guard member and the second guard member and further sealingly engaging the shaft assembly. The seal member is positioned within the interior guard volume.

### BACKGROUND AND SUMMARY

This section provides background information related to the present disclosure which is not necessarily prior art. This section further provides a general summary of the disclosure, and is not a comprehensive disclosure of its full scope or all of its features.

Gear spindles in metal rolling mill applications typically operate under harsh environmental and load conditions. Furthermore, these metal rolling mills typically operate for extended periods of time throughout the day, which limits available time for maintenance and repair. Accordingly, adequate lubrication is critical to their successful and reliable operation.

Gear spindles are commonly lubricated on a weekly basis during a scheduled maintenance shut down. As it should be appreciated, manufacturers strive to both minimize the time allotted for scheduled maintenance and repair, while simultaneously striving to maximize longevity of the machinery. Therefore, in many applications, it is critical that maintenance, such as application of lubricants, is a quick and reliable process that ensures that each unit receives adequate care to extend its useful life.

Conventionally, gear spindles typically incorporate a seal, such as a rubber lip or rising ring, for a multi-faceted purpose—namely, to keep lubrication within the gearing and to keep out contaminants that may affect the overall reliability and longevity of the machinery. In the most environmentally-severe applications, a secondary bellow-type seal is occasionally added to prevent rolling solution and other contaminants from entering the gear spindle area and damaging the gearing and other sensitive parts.

However, a common maintenance practice when lubricating gear spindles is to add grease to the gear spindle until the maintenance technician or operator sees grease purge past the primary seal. This purged grease technique serves to, at least in part, purge used and possibly contaminated grease from within the gearing area of the gear spindle and further serves as a visual cue that the internal volume is substantially filled with lubricating grease.

Unfortunately, in the aforementioned environmentally-severe applications, the use of the secondary bellow-type seal, which intentionally covers the primary seal, prevents the maintenance technician or operator from being able to see and thus witness the grease purging past the primary seal. These secondary seals are typically coupled to the gear spindle using a plurality of fasteners. Because of the number and difficulty in removing these fasteners, maintenance technicians typically do not remove such secondary seals when performing maintenance. Therefore, when using a conventional secondary bellow-type seal, it is impossible to confirm that contaminated grease has been purged and the gearing area substantially refilled. Moreover, if a maintenance technician or operator proceeds with lubricating a conventional gear spindle with a secondary bellow-type seal in place, the volume within the secondary bellow-type seal will eventually become filled with purged grease and is likely to rupture. Consequently, such rupture would result in increased exposure of the sensitive components to contaminants, increased downtime, and increased maintenance and repair costs.

Accordingly, there exists a need in the relevant art to provide a seal system for providing the increased protection of a secondary bellow-type seal, without the disadvantages associated with conventional systems.

Therefore, according to the principles of the present teachings, a quick release bellow seal guard for use with a shaft assembly is provided having advantageous construction. The seal guard comprises a first guard member having an open central region and a second guard member releasably coupled to the first guard member also having an open central region. The first guard member further includes a wall extending from a base portion to a distal end. The second guard member further includes a proximal end releasably coupled to the distal end of the first guard member to collectively define an interior guard volume. The quick release bellow seal guard further includes a seal member sealingly engaging at least one of the first guard member and the second guard member and further sealingly engaging the shaft assembly. The seal member is positioned within the interior guard volume.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustrating a conventional rolling mill stand employing the quick release bellow seal guard of the present teachings;

FIG. 2 is a side view illustrating a gear spindle employing the quick release bellow seal guard of the present teachings;

FIG. 3 is an enlarged cross-sectional view illustrating the quick release bellow seal guard of the present teachings according to some embodiments;

FIG. 4 is an enlarged cross-sectional view illustrating the quick release bellow seal guard of the present teachings according to some embodiments;

FIG. 5 is an end view illustrating a clamping ring assembly according to the present teachings;

FIG. 6 is an enlarged view illustrating the swing-bolt clamp according to the present teachings;

FIG. 7 is a side view illustrating a hinge portion of the swing-bolt clamp;

FIG. 8 is a top view illustrating a hinge portion of the swing-bolt clamp;

FIG. 9 is a cross-sectional view illustrating the quick release bellow seal guard of the present teachings in a closed position; and

FIG. 10 is a cross-sectional view illustrating the quick release bellow seal guard of the present teachings in an opened position.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

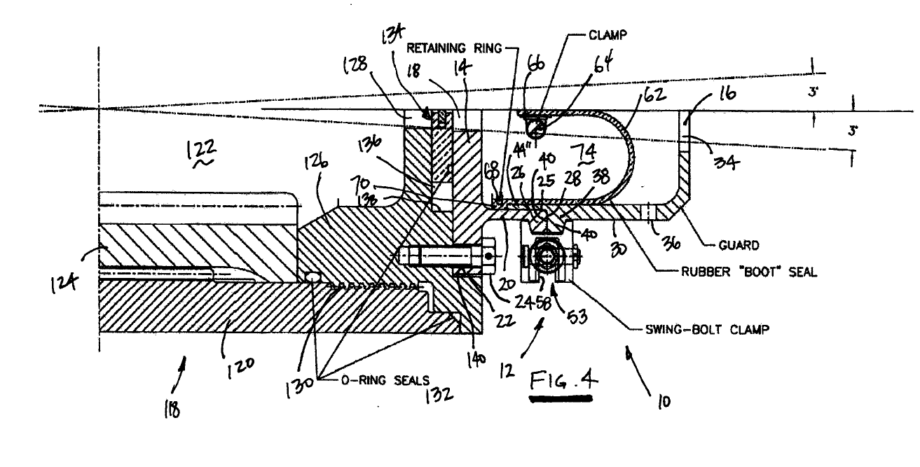

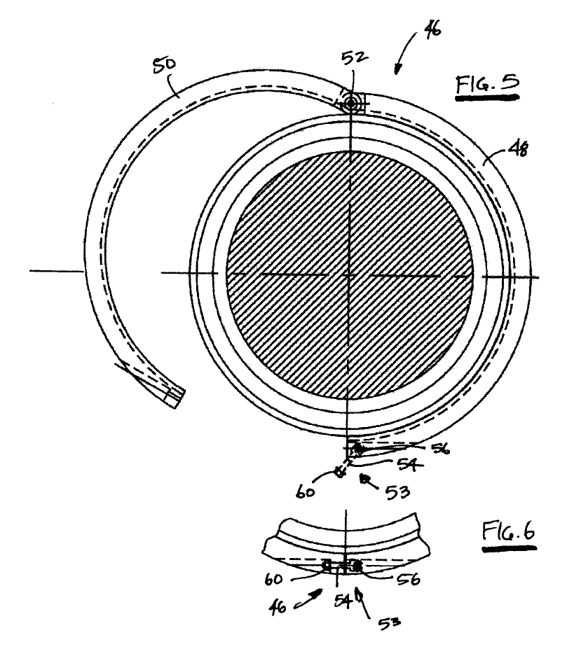

With particular reference to the figures, a quick release bellow seal guard 10 (FIGS. 2-10) is illustrated in connection with a gear spindle assembly 100. However, it should be appreciated that quick release bellow seal guard 10 can be used in connection with a wide variety of applications, such as gear spindles, gear couplings, universal drive shafts, constant velocity joints, lubricated couplings, monitoring equipment, and any other shaft-like members where use of a quick disconnect seal is beneficial and convenient access to the inner volume is desired.

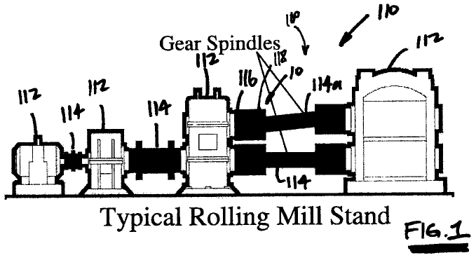

With continued reference to the figures, particularly FIG. 1, gear spindle assembly 100 is schematically illustrated in use with a conventional rolling mill stand 110. Rolling mill stand 110 can comprise a plurality of machines 112 being operably couple therebetween via drive shafts or gear spindles 114. In some embodiments, gear spindles 114 can be used in pairs. Additionally, as seen in FIG. 1, such pairs of gear spindles 114 can be disposed at an angle (see 114a in FIG. 1) relative to an adjacent gear spindle 114b and/or power connection system 116. This angle can lead to misalignment, such as 1 to 3 degrees or more, between gear spindle 114 and power connection system 116 and thus potentially lead to increased exposure to environmental contaminants in a single seal configuration. These environmental contaminants and the lack of lubrication are major factors leading to gear spindle wear and replacement. It has been found that conventional gear spindle designs employing conventional seal configurations may have a useful life of about 6 months to 2 years. However, superior seal design, such as that afforded by the present teachings, can provide the reliability and reduced down time necessary for enhanced market competition.

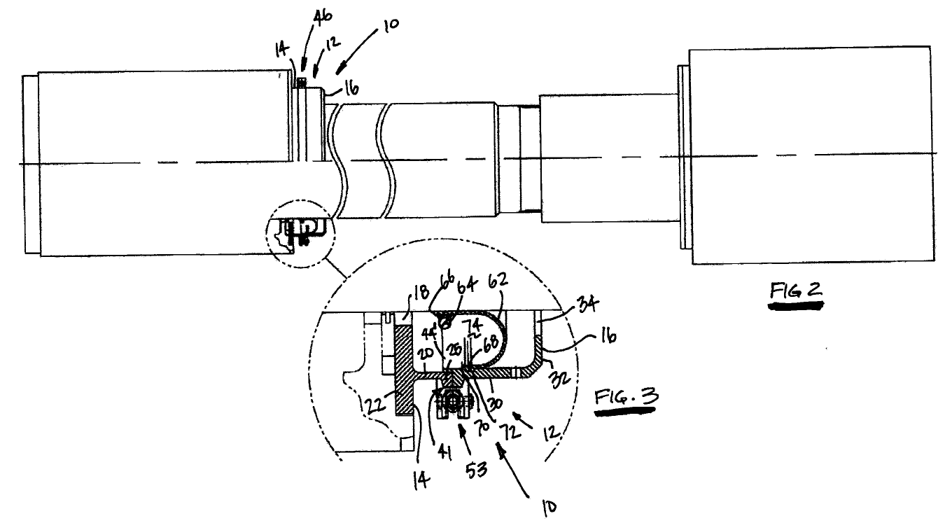

With particular reference to FIGS. 2-4, gear spindle assembly 100 generally comprises a collar assembly 118 generally surrounding at least one end of gear spindle 114. Collar assembly 118 can comprise a housing member 120 defining a cylindrical volume 122 (FIG. 4). As illustrated in FIG. 4, a gear 124 is fixed coupled to housing member 120 and disposed within cylindrical volume 122. A cap member 126, having an open central region 128 (FIG. 3) for receiving gear spindle 114 therethrough, is fixedly coupled to housing member 120 via conventional methods, such as threadedly engaging generally indicated at 130. In some embodiments, as plurality of O-rings 132 can be used to maintain a fluid seal between housing member 120 and cap member 126.

In some embodiments, gear spindle assembly 100 further comprises a primary seal assembly 134 in sealing engagement with gear spindle 114 to define a fluid seal therebetween to prevent or, at least, minimize inadvertent passage of lubricant, such as grease, from cylindrical volume 122 to a space outside of cylindrical volume 122. Mounting of primary seal assembly 134 can be configured in any one of a number of ways. However, with reference to FIG. 4, in some embodiments, primary seal assembly 134 can be a rubber lip or rising ring disposed within a recess 136 formed in cap member 126. Specifically, recess 136 can be coaxially aligned with open central region 128 and to a depth sufficient to form a shoulder 138. The depth of recess 136 can further be sufficient to retain primary seal assembly 134. In some embodiments, as will be discussed in greater detail below, primary seal assembly 134 can be press fit or slidably disposed between cap member 126 and a base guard member of the present teachings.

According to the principles of the present teachings, quick release bellow seal guard 10 provides a method for employing a secondary seal in conjunction with primary seal assembly 134, wherein the secondary seal is quickly and conveniently releasable and reattachable to expose primary seal assembly 134 for inspection and maintenance, and further provides necessary sealing engagement under a wide variety of applications, alignments, and environments.

In some embodiments, as seen in FIGS. 2-6, quick release bellow seal guard 10 can comprise a guard assembly 12 having a fixed guard member 14 and a moveable guard member 16. Fixed guard member 14 can be generally circular in construction having an open central region 18 to permit passage of gear spindle 114 therethrough. As seen in FIG. 4, open central region 18 can be sized to permit deflection and/or misalignment of gear spindle 114. In some embodiments, this misalignment can be as great as 3 degree prior to contact of gear spindle 114 with fixed guard member 14. It should be appreciated, however, that open central region 18 can be further enlarged to permit great misalignments or to accommodate additional structural variations of the particular application.

In some embodiments, fixed guard member 14 can be sized to be received within a guard recess 140 formed in cap member 126 or added to an existing design as in a retrofit application. Guard recess 140 can be coaxial with recess 136 to maintain proper alignment of fixed guard member 14 with cap member 126. Moreover, as indicated above, fixed guard member 14 can cooperate with cap member 126 to further retain and/or position primary seal assembly 134 relative to gear spindle 114 for proper sealing engagement.

Still referring to FIGS. 2-6, fixed guard member 14 can comprise an outwardly-extending, circular wall 20 extending orthogonally from a base portion 22 and coaxial with open central region 18. Base portion 22 can be sized to be received within guard recess 140. Fixed guard member 14 can be fixedly coupled to cap member 126 via conventional methods, such as one or more threaded fasteners 24. A distal end 25 of circular wall 20 can terminate at a flange 26 having a mounting face 28.

Moveable guard member 16 can define a generally dome or generally cylindrical shape and can be releasably connectable with fixed guard member 14. Specifically, moveable guard member 16 can comprise a cylindrical sidewall 30 terminating at an optional end wall 32. As seen in FIG. 4, end wall 32 can comprise an open central region 34 sized to permit gear spindle 114 to extend therethrough and further permit deflection and/or misalignment of gear spindle 114. In some embodiments, as discussed herein, this misalignment can be as great as 3 degree prior to contact of gear spindle 114 with moveable guard member 16. It should be appreciated, however, that open central region 34 can be further enlarged to permit great misalignments or to accommodate additional structural variations of the particular application. It should also be appreciated that end wall 32 can be eliminated in some embodiments, if desired. Moveable guard member 16 may further comprise a drainage aperture 36 extending through sidewall 30 to permit drainage of liquids and/or air to escape from a volume within at least a portion of collar assembly 12.

Moveable guard member 16 can further comprise a complementary proximal end 38 for connection with distal end 25 of circular wall 20 of fixed guard member 14. In some embodiments, proximal end 38 of moveable guard member 16 can comprise a flange 40 having a mounting face 42 engaging mounting face 28 of wall 20 to form a collective enlarged portion 41. Proximal end 38 can further comprise an extended shoulder portion 44 extending inwardly along an interior surface of circular wall 20 of fixed guard member 14. It should be appreciated that such a complementary end of moveable guard member 16 can be of any shape conducive for engagement with distal end 25 of fixed guard member 14. For example, in some embodiments as illustrated in FIGS. 3, 9, and 10, proximal end 38 can comprise a shortened shoulder portion 44′ underlapping wall 20. In some embodiments as illustrated in FIG. 4, proximal end 38 can comprise an elongated shoulder portion 44″. The specific shape of the complementary ends can be varied as required. Additionally, it should be appreciated that proximal end 38 and distal end 25 can be shaped to provide any one of a number of preferred fits, such as a press-fit, interference-fit, snap-fit, and other locking shapes and fits. It should also be appreciated that depending upon this engagement, in some applications, additional locking systems (such as clamping ring assembly 46) can be eliminated.

However, in some embodiments, moveable guard member 16 can be fixedly coupled to fixed guard member 14 using a clamping ring assembly 46 or other releasable locking device. Clamping ring assembly 46 and/or releasable locking device can be substantially removable from at least one of moveable guard member 16 and fixed guard member 14 to permit moveable guard member 16 to be spaced apart from fixed guard member 14 into an opened position.

Specifically, as seen in FIGS. 2-8, clamping ring assembly 46 can be generally circular shaped having a first ring half 48 and a second ring half 50 pivotally coupled at a hinge 52. First ring half 48 and second ring half 50 can define a cross-sectional shape complementary to an external shape of flange 26 of fixed guard member 12 and flange 40 of moveable guard member 16. In some embodiments, this cross-sectional shape can define a generally U-shaped or V-shaped configuration. Clamping ring assembly 46 can be fitted over flange 26 and flange 40 to create a locking engagement effectively preventing moveable guard member 16 from being removed from fixed guard member 14 and, in some embodiments, providing a sealing engagement. In some embodiments, first ring half 48 and second ring half 50 can be retained in locking engagement using a fastener, such as a swing-bolt clamp 53. As seen in FIGS. 4-6, swing-bolt clamp 53 can comprise a bolt member 54 coupled with first ring half 48 and freely pivotable about an axis 56 at one end. An opposing end of bolt member 54 can be received within a U-shaped slot 58 formed in second ring half 50 (see FIG. 4). A nut 60, threadedly engaged with bolt member 54, can be tightened to fixedly retain first ring half 48 to second ring half 50. To remove clamping ring assembly 46, nut 60 can be loosened to permit first ring half 48 and second ring half 50 to be removed from flange 26 and flange 40. Once clamping ring assembly 46 is removed, moveable guard member 16 can be slidably disconnected or disengaged from fixed guard member 14 to reveal primary seal assembly 134.

As seen in FIGS. 3, 4, 9, and 10, quick release bellow seal guard 10 can further comprise a secondary seal member 62. In some embodiments, secondary seal member 62 can comprise a bellows-type seal being made of a generally flexible sheet-like material. It should be understood that secondary seal member 62 can be made of any material resistant to environmental contaminants and materials (such as grease and the like) and suitable for the environment (such as various temperatures and pressures), and contaminants in which it is used.

Secondary seal member 62 can be fixedly coupled along one end to gear spindle 114 and another end to extended shoulder portion 44. In some embodiments, secondary seal member 62 is fixedly coupled to gear spindle 114 using a circular clamp 64. Circular clamp 64 can be arranged such that an edge 66 of secondary seal member 62 is retained in contact with gear spindle 114. Circular clamp 64 can then be tightened to apply a clamping force upon edge 66 to maintain secondary seal member 62 in a predetermined position. Similarly, secondary seal member 62 is fixedly coupled to extended shoulder portion 44 of moveable guard member 16 using a retaining ring 68. Retaining ring 68 can be arranged such that an edge 70 of secondary seal member 62 is retained in contact with moveable guard member 16. Retaining ring 68 can then be expanded, such as through the natural properties of the material of retaining ring 68 and/or through the physical design properties of retaining ring 68 (i.e. such as a preformed, expanding-biased ring member), to apply a retaining force upon edge 70 to maintain secondary seal member 62 in a predetermined position. It should be appreciated that retaining ring 68 can be used to maintain engagement of edge 70 of secondary seal member 62 at any position, such as within a slot 72 (FIG. 3) formed in an interior surface of sidewall 30 or in engagement with wall 20 of fixed guard member 14 (FIG. 4).

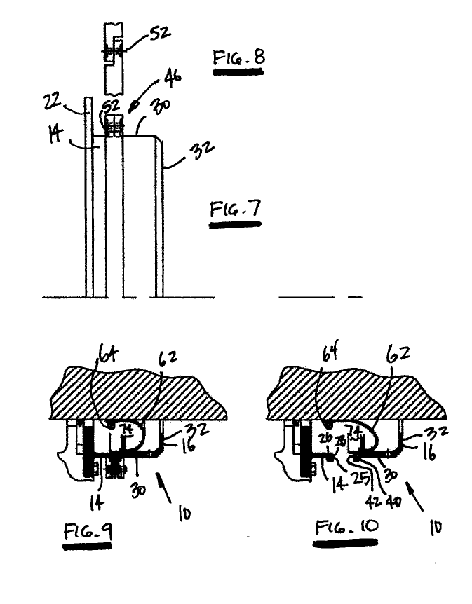

As seen in FIGS. 9 and 10, during a maintenance operation, nut 60 of swing-bolt clamp 53 can be loosened to remove clamping ring assembly 46 as described earlier. Once swing-bolt clamp 53 is loosened or removed, moveable guard member 16 can be slide (to the right in the figures) to an opened position (FIG. 10) from the closed position (FIG. 9). Such movement creates a convenient line of sight to primary seal assembly 134 to observe its condition and/or observe a maintenance process (such as purged lubricant). The simplicity of this operation should be appreciated in that exposure of primary seal assembly 134 can be achieved through the loosening of a single retaining member (bolt 60), however the benefits of a secondary seal member is still achieved.

Accordingly, the principles of the present teachings can enable mill personnel and/or maintenance technicians to quickly detach and reattach the secondary seal member, which allows mill personnel to view the grease purging past the primary seal assembly and eliminate the purged grease from within an interior guard volume 74 disposed within secondary seal member 62 to prevent subsequent damage to secondary seal member 62. Moveable guard member 16 and fixed guard member 14 serve to protect secondary seal member 62 from damage caused by inadvertent contact from other equipment or personnel during operation or maintenance.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A quick release bellow seal guard for use with a shaft assembly, said quick release bellow seal guard comprising:
a fixed guard member fixedly connectable to the shaft assembly, said fixed guard member having an open central region sized to permit a shaft member of the shaft assembly to pass therethough, said fixed guard member further comprising a wall extending from a base portion to a distal end;
a moveable guard member releasably coupled to said fixed guard member, said moveable guard member having an open central region sized to permit the shaft member of the shaft assembly to pass therethrough, said moveable guard member having a proximal end complementarily engagable with said distal end of said fixed guard member to collectively define an interior guard volume;
a releasable locking device releasably coupling said moveable guard member to said fixed guard member in a closed position, said releasable locking device being substantially removable from at least one of said moveable guard member and said fixed guard member to permit said moveable guard member to be spaced apart from said fixed guard member; and
a seal member sealingly engaging at least one of said fixed guard member and said moveable guard member and further sealingly engagable with the shaft assembly, said seal member being positioned within said interior guard volume.

2. The quick release bellow seal guard according to claim 1, further comprising:
a circular clamp fixedly coupling said seal member with the shaft member of the shaft assembly.

3. The quick release bellow seal guard according to claim 1, further comprising:
a retaining ring fixedly coupling said seal member to at least one of said fixed guard member and said moveable guard member.

4. The quick release bellow seal guard according to claim 1, further comprising:
a first flange portion disposed on said distal end of said fixed guard member;
a second flange portion disposed on said proximal end of said moveable guard member, said second flange portion engaging said first flange portion to form a collective enlarged portion; and
said releasable locking device having a generally U-shape or V-shape positioned over said collective enlarged portion to retain said fixed guard member and said moveable guard member in said closed position.

5. The quick release bellow seal guard according to claim 1 wherein said releasable locking device comprises:
a first ring half having a first end and a second end;
a second ring half having a first end pivotally coupled with said first end of said first ring half and a second end; and
a fastener lockingly engaging said second end of said first ring half with said second end of said second ring half to exert a retaining force on said fixed guard member and said moveable guard member.

6. The quick release bellow seal guard according to claim 5 wherein said fastener is a swing-bolt clamp.

7. The quick release bellow seal guard according to claim 1 wherein said proximal end of said moveable guard member comprises a shoulder portion extending within and closely conforming to said fixed guard member.

8. The quick release bellow seal guard according to claim 1 wherein said proximal end of said moveable guard member being complementarily engagable with said distal end of said fixed guard member comprises a locking fit.

9. A quick release bellow seal guard for use with a shaft assembly, said quick release bellow seal guard comprising:
a first guard member fixedly having an open central region, said first guard member further having a wall extending from a base portion to a distal end;
a second guard member releasably coupled to said first guard member, said second guard member having an open central region, said second guard member having a proximal end releasably coupled to said distal end of said first guard member to collectively define an interior guard volume; and
a seal member sealingly engaging at least one of said first guard member and said second guard member and further sealingly engagable with the shaft assembly, said seal member being positioned within said interior guard volume.

10. The quick release bellow seal guard according to claim 9, further comprising:
a releasable locking device releasably coupling said second guard member to said first guard member in a closed position, said releasable locking device being substantially removable from at least one of said second guard member and said first guard member to permit said second guard member to be spaced apart from said first guard member.

11. The quick release bellow seal guard according to claim 9, further comprising:
a circular clamp fixedly coupling said seal member with a shaft member of the shaft assembly.

12. The quick release bellow seal guard according to claim 9, further comprising:
a retaining ring fixedly coupling said seal member to at least one of said first guard member and said second guard member.

13. The quick release bellow seal guard according to claim 9, further comprising:
a first flange portion disposed on said distal end of said first guard member;
a second flange portion disposed on said proximal end of said second guard member, said second flange portion engaging said first flange portion to form a collective enlarged portion; and
said releasable locking device having a generally U-shape or V-shape positioned over said collective enlarged portion to retain said first guard member and said second guard member in said closed position.

14. The quick release bellow seal guard according to claim 9 wherein said releasable locking device comprises:
a first ring half having a first end and a second end;
a second ring half having a first end pivotally coupled with said first end of said first ring half and a second end; and
a fastener lockingly engaging said second end of said first ring half with said second end of said second ring half to exert a retaining force on said first guard member and said second guard member.

15. The quick release bellow seal guard according to claim 14 wherein said fastener is a swing-bolt clamp.

16. The quick release bellow seal guard according to claim 9 wherein said proximal end of said second guard member comprises a shoulder portion extending within and closely conforming to said first guard member.

17. The quick release bellow seal guard according to claim 9 wherein said proximal end of said second guard member being complementarily engagable with said distal end of said first guard member comprises a locking fit.
